(19) United States
(12) Patent Application Publication
(10) Pub. No.: US 2009/0314252 A1
(43) Pub. Date: Dec. 24, 2009

(54) COMBUSTION ENGINE WITH SELF-IGNITION OF AIR-AND-FUEL MIXTURE

(76) Inventor: Joseph Perewusnyk, Praha (CZ)

Correspondence Address: BUCHANAN, INGERSOLL & ROONEY PC, POST OFFICE BOX 1404, ALEXANDRIA, VA, 22313-1404, US

(21) Appl. No.: 12/302,620

(22) PCT Filed: May 23, 2007
(86) PCT No.: PCT/CZ2007/000036

§ 371 Date: Jun. 9, 2009

(30) Foreign Application Priority Data
Jun. 1, 2006 (EP) 06466004.6

(51) Int. Cl. F02B 47/02; F01L 9/04

(52) U.S. Cl. 123/25 P; 123/90.11

(57) ABSTRACT

Combustion four-cycle engine, in which two pairs of pistons (1) make identically oriented movements by means of action of two gear wheels against gear rods of both pistons and its inertia forces are compensated by the third pair of pistons (10) of identical mass, which moves in the opposite direction, fuel is injected into cylinder in each stroke and after compression it is combusted by self-ignition (9), this engine operates with additional steam boiler driven by high amount of heat released during cooling the engine and also by the exhaust gases heat. By releasing the steam, part of this energy is exploited in the engine's middle cylinder thus significantly increasing economy of such engine. The middle cylinder is used for production of electrical current by means of a linear action electromotor with at least such output power to cover electric energy demands of a vehicle powered by this engine, while maximum power output of the engine may transform into electrical power. This linear electromotor/generator is also used as a starter for this engine. Starting motor may be used for this purpose as the most simple alternative to this linear electromotor. Hydraulic conversion of the power does not require identical direction of rotation, it is much simpler than all other methods of exploiting this engine's power described herein.

### FIELD OF TECHNOLOGY

The invention deals with design of a four-cycle combustion engine with 4 combustion chambers, in which the air sucked in, or air optionally delivered by a compressor or turbocompressor, mixed with adequate amount of fuel, gets self-ignited, thus driving the engine, while the moment of the air-and-fuel mixture self-ignition may vary depending on load, individual self-ignitions frequency, engine and mixture temperature, and the engine's power is transformed mechanically, electromagnetically or hydraulically and the engine's degree of efficiency is further enhanced by the fact that part of the energy created during cooling the engine and certain portion of the exhaust gases heat energy are exploited for pressurized steam production and expansion of such steam in the engine's middle cylinder realizes sufficient power and this steam, after expansion, is again cooled by an air flow, condensed and returned back to circulation in the engine.

### CURRENT STATE OF TECHNOLOGY

At present, combustion engines are realized with crank-shaft, which transforms linear movements of pistons in separate cylinders to rotational movement of the crank-shaft with certain power loss.

Spark ignition engine's degree of efficiency is inter alia limited by the self-ignition limit, so-called engine knocking.

For compression ignition engines such self-ignition limit does not apply, air compression level is limited mainly by so-called blow-by amount and by strength of the structure.

### SUMMARY OF THE INVENTION

This invention aims to newly deal with the above-mentioned disadvantages of present engines in order to decrease heat losses, thus increasing the engine's decree of efficiency and partially also eliminating the need for increasing the fuel's octane rating.

The engine's design according to the invention is characterized by the fact that inside the four-cycle engine's cylinders the movement of two pair of pistons is synchronized by means of two gear wheels in such a manner that inertia forces of these two pairs of pistons are compensated by another pair of pistons of the same mass moving in their middle in opposite direction.

The engine has no spark plugs, and therefore also no ignition distributor. Air-and-fuel mixture gets ignited by increasing its temperature after compression due to so-called self-ignition.

In order to decrease the rise of pressure in the engine created by such self-ignition and also to decrease the amount of harmful substances, in particular NO_{X} and NO, the engine typically works with the lambda value of 1.3-5.0, only during start and short warm-up phase this engine operates with the lambda value equal to 1.0.

Power of this engine is, as already mentioned above, transformed either mechanically, hydraulically or electrically.

Mechanical transformation means that the back-and-forth movement of two pairs of pistons and also the opposite-oriented movement of two pistons located between them are transformed by means of two clutches, which alternately engage in one direction of rotational movement, while they slip in the opposite direction and vice versa.

Hydraulically, the engine's power is realized by drawing the hydraulic liquid to the middle cylinder and distributing it at firing cycle to a hydraulic engine or turbine and thus it is transformed to the engine's output power.

For starting this engine and also for production of electric current in full range of power ratings a linear electromotor is used in the area of the middle valve/piston.

The following part describes the invention in closer detail on examples of design shown in the drawings.

### BRIEF DESCRIPTION OF THE DRAWINGS

FIG. 1 shows schematically longitudinal section of the combustion engine consisting of two halves of cylinder bolted together in the middle, two coupled pairs of pistons with normal sealing rings, four combustion chambers, four or five valves per each head and always one injection nozzle per each head of the cylinder and two coupled compensating pistons located in the middle of these cylinders, while these pistons move by means of two gear wheels in direction opposite to the pistons of the combustion engine. All pistons move inside the cylinders without contact, they pass through lubricated gear rods, which pass precisely and without clearance through two gear wheels, and the pistons in the middle pair of cylinders move by means of two identical gear wheels interlocked to the both-sides-geared coupling rod between the pistons of the middle pair of cylinders.

Four or five valves respectively per one cylinder head, two suction valves and two exhaust valves, or three suction valves and two exhaust valves respectively, are actuated pneumatically, piezoelectrically or electromagnetically, and exactly identically as the mentioned four or five valves per each cylinder head between them, which compensate the mass, and thus the movement of these pairs of pistons is controlled and may vary within certain limits.

FIG. 2 shows schematically longitudinal section of the combustion engine according to the FIG. 1 with the following alterations: The pistons are not equipped with piston rings and front areas of pistons are ball-shaped. The reason is that this type of engine is designed for higher temperatures of pistons and also of cylinders and cylinder heads, for which no lubricant would be suitable. The engine is running “dry”, the blow-by amount is limited by suitable labyrinth structures on the pistons, all pistons are cooled inside the cylinders by water or water steam.

FIG. 3 shows schematically one of the two linear electromotors located in the middle cylinder between both engine cylinders, which serves for electrical current production.

FIG. 4 shows schematically both positioning of valves and injection nozzles in the engine and also the bolted connection of both halves of the cylinder.

FIG. 5 shows schematically two disc clutches, while one of them engages in direction of the piston and the other slips, and during the following counter-motion they act vice versa—this clutch slips and the second clutch engages, thus transforming the engine's power.

FIG. 6 shows one of total two disc clutches engaging in the opposite direction with onset of always 1°.

FIG. 7 shows clutch designed for higher powers, which slips in the like direction, and another clutch of the same type designed in the opposite way, which engages in the opposite direction and slips in the like direction.

FIG. 8 shows schematically longitudinal section of the combustion engine for suction and in the next step drawing the hydraulic liquid in the full range of the engine's power.

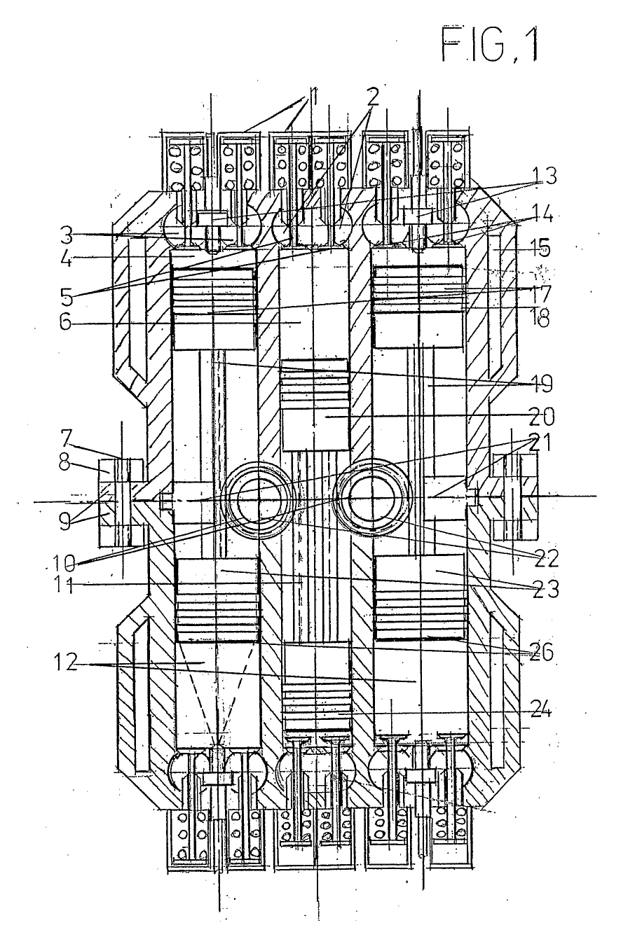

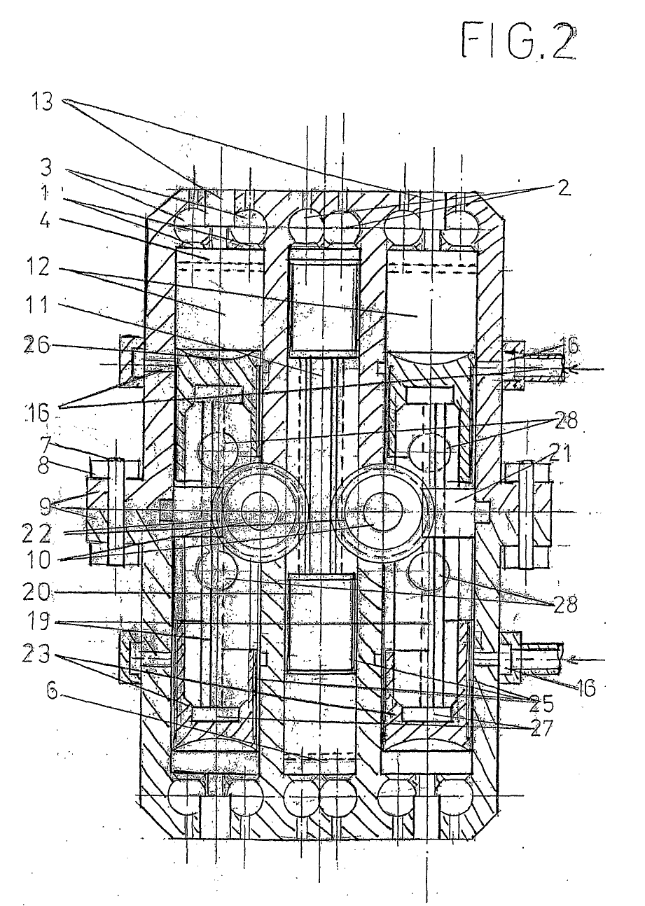

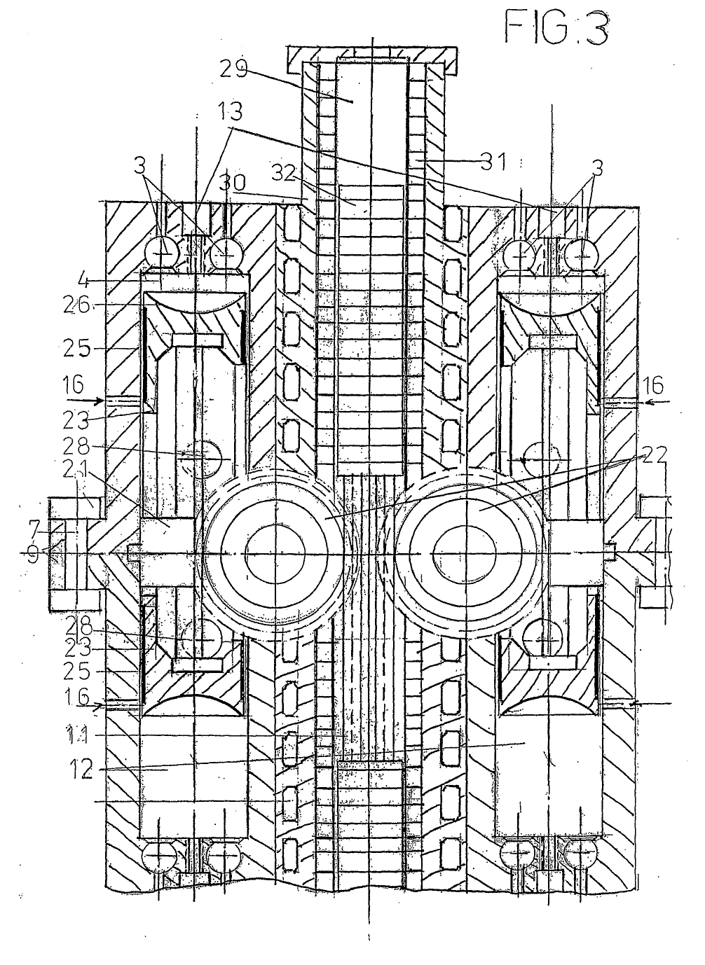

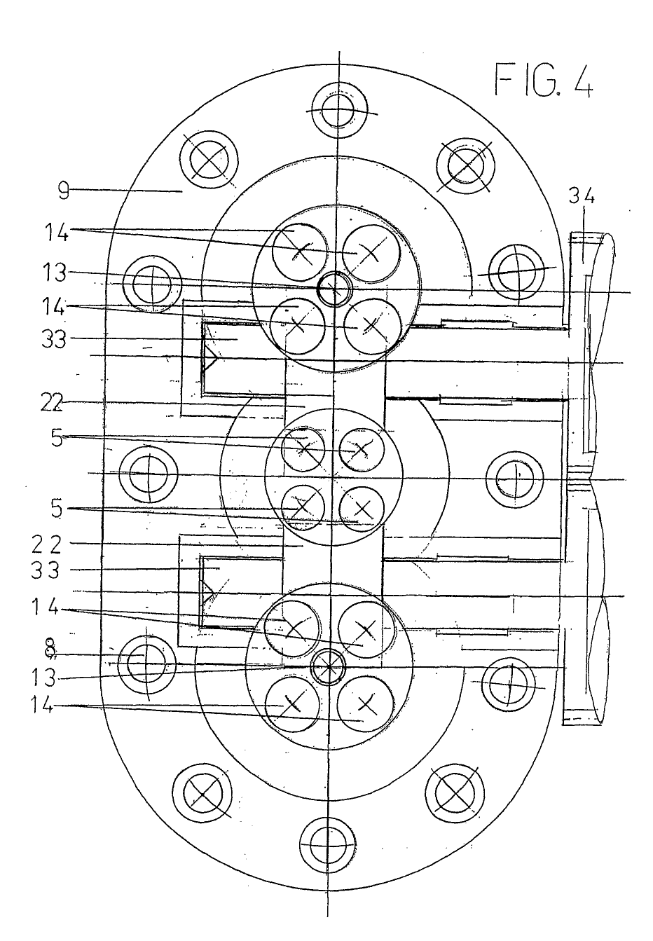

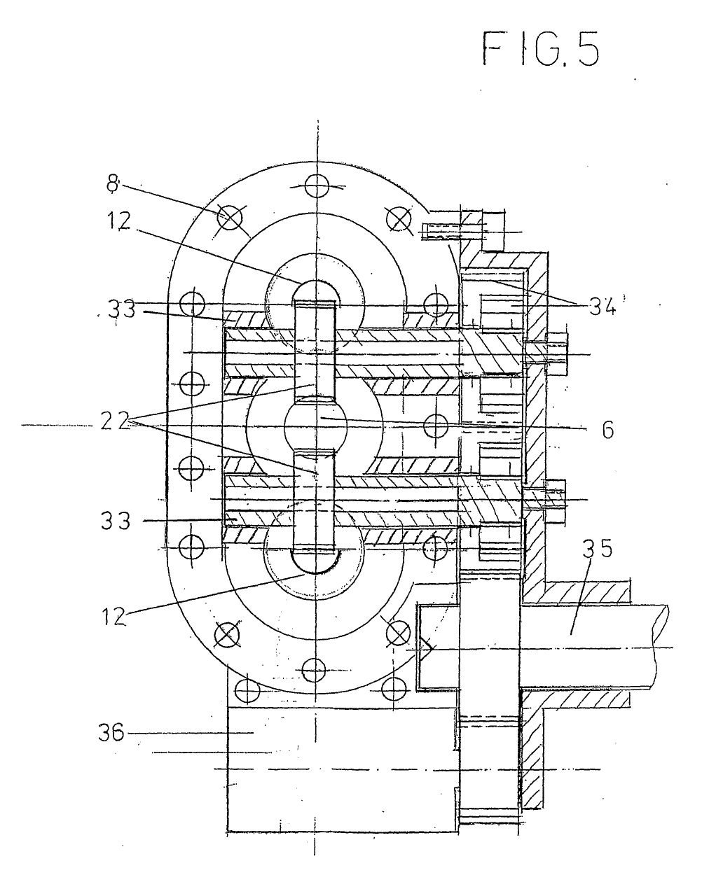

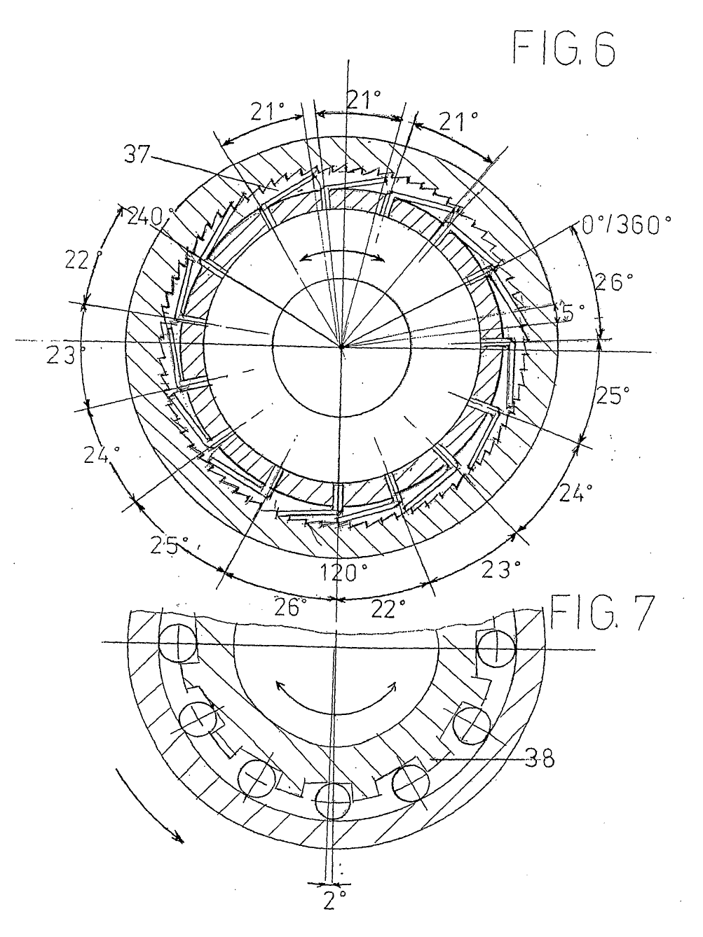

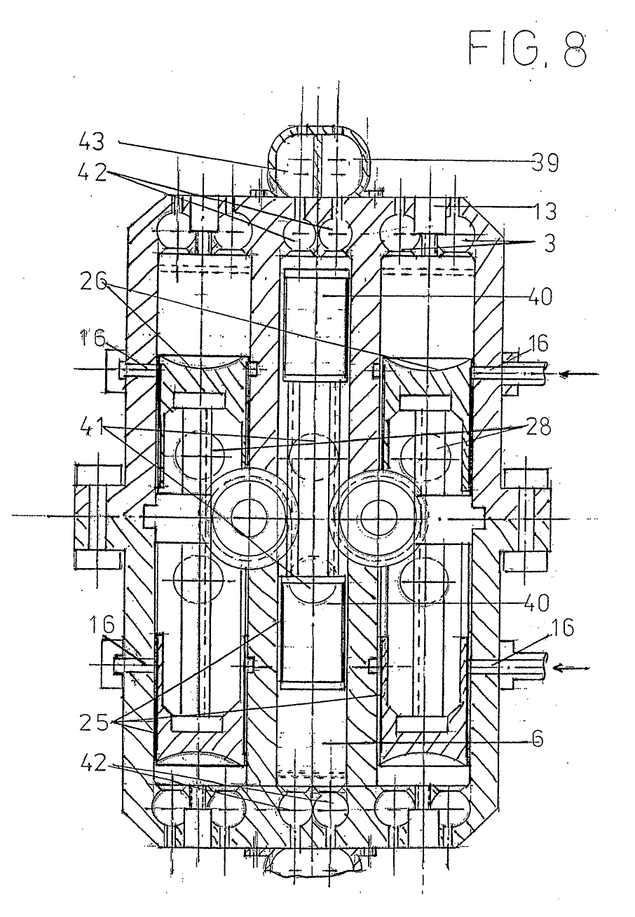

If in the next description the elements in various forms of design perform the same function, they are assigned the same reference numbers.

1. Combustion engine with four pistons (23), which are coupled in pairs always by two by means of two gear wheels interlocking with gear coupling elements (19), and therefore they move identically inside the cylinders, and during each stroke the air-and-fuel mixture previously sucked in or delivered by turbocompressor or mechanical compressor gets ignited with lambda value from 1.0 to 5.0, while self-ignition is involved under corresponding temperature values, and the highest pressure has high maximum values, position of the upper part of pistons (26) towards the cylinder head may vary depending on temperature of the cylinder heads, sucked-in or delivered air-and-fuel mixture and generally according to the engine's load, mass of these two pairs of pistons (23) including the two gear coupling elements (19) is compensated by identical mass of a pair of pistons (20) including the gear coupling element (11), which is by means of two gear wheels (22) driven in opposite direction, regardless of the path the two pairs of pistons (23) have traveled to ignition in some of the cylinders, and this middle pair of pistons (20) in cylinders (6) serves in addition as a steam engine, the steam for this purpose is produced in a boiler driven by the heat of cooling water and also by temperature rise and therefore by the steam pressure due to subsequently implemented warming by hot exhaust gases, while this middle piston and cylinder (20) and (6) are in addition equipped with linear electromotor/generator (31), (32), with such minimum power output to cover charging the vehicle's accumulator for general use as well as for starting, while this engine operates under typical temperatures of internal parts of cylinders from 90 to 120° C.

2. Combustion engine according to claim 1, wherein these two halves of the cylinder (9) are exactly in the middle in corresponding holes coupled by bolts (7) and by nuts (8) and they have identical position of gear coupling elements of pistons (19) and are secured by inserted and lubricated supports (21).

3. Combustion engine according to claim 1, wherein the pistons front sides are equipped with protective layer (16) and (26), which can stand high pressure impacts and high temperatures during self-ignition without damage.

4. Combustion engine according to claim 1, wherein all suction valves and exhaust valves (14) and also the valve on the middle cylinder head (5) are controlled electromagnetically, piezoelectrically or pneumatically based on processed signals from sensors monitoring movements of pistons in the phase of close-to-zero speed and simultaneously the corresponding valves of the engine (14) and valves of the middle cylinder head (5) open and remain opened for 80-90% of the whole stroke.

5. Combustion engine according to claim 2, wherein the engine operates at high temperatures of sucked air-and-fuel mixture of 150 -250° C., which makes lubrication of the engine's pistons impossible, pistons tightness in cylinders is ensured by suitable choice of operating means for both components with very low expansion factor ox, flat grooves designed in the pistons' working area to reduce the blow-by amount, while into the engine operating with sucked air of such high temperatures the cooling water is delivered by an inlet with minimum twelve holes into the space between piston and cylinder (16), which transforms there into steam and is led by four openings (28) to the cooler.

6. Combustion engine according to claim 2, wherein surfaces of cylinders, cylinder heads, flat parts of valves as well as the front sides of pistons are made, or rather their surface is made of absolutely smoothly processed material, in particular white magnesium oxide or chrome, with reflection factor 95% or 70% respectively, allowing to reflect substantial part of the light energy in the range from 0.20 to 400 μm, thus increasing the temperature and pressure of gases in cylinders and subsequently the cooling decreases the engine's losses.

7. Combustion engine according to claim 2, wherein during its suction cycle, with air or air-and-fuel mixture temperature from 150 to 250° C., there is water steam additionally delivered in the amount from 100 to 1000 g/m³, depending on operated loads and the engine's revolutions, in order to increase absorption of visible-to-infrared light energy during ignition and expansion giving pressure rise during the whole expansion cycle, to decrease extremely high temperatures generated during such procedure and thus to increase the engine's power without problems with selection of materials for valves and pistons, all this without any additional fuel consumption.

8. Combustion engine according to claim 2, wherein increased heat generated in this engine during suction of air or air-and-fuel mixture, and also during cooling of the engine, and certain amount of the exhaust gases heat are brought to attached boiler for high-pressure steam production, which along with delivered power relieves the middle cylinder of the engine (6) or the attached turbine, thus increasing the overall power output without additional fuel consumption.

9. Combustion engine according to claim 1, wherein contactless movement of two pairs of pistons and the third pair of pistons moving in the opposite direction is transformed to the rotational movement by two gear wheels (22).

10. Combustion engine according to claim 1, wherein limited back-and-forth movement of these two gear wheels (22) is transformed by two clutches to unidirectional rotation (35) and output power.

11. Combustion engine according to claim 1, wherein either a linear electromotor/generator (31) and (32) or electric generator (36) triggers brake power if necessary.

12. Combustion engine according to claim 11, wherein this motor does not need like direction of rotational movement of gear wheels (22), its electrical output power is distributed to one to four electromotors.

13. Combustion engine according to claim 1, wherein this engine sucks in the middle cylinder (29) a hydraulic liquid, compresses it during the next stroke and feeds it to one or maximum four hydraulic motors.

14. Combustion engine according to claim 1, wherein this engine sucks in pure air and almost in the end of compression, at high pressure and temperature of the content, the diesel, oil or other kind of fuel is injected and therefore the pressure peak during combustion reaches significantly lower values compared to alternatives 1 to 13 and due to course of injected amounts and using high-pressure injection of up to 1000 bar it may be kept within currently common limits without further design demands, this procedure is always used during starting the engine.

15. Combustion engine according to claim 1, wherein it sucks in ignitable air-and-fuel mixture, during compression close to the piston's upper dead point this mixture ignites by a spark plug with common igniter device, while the injection nozzles (13) are replaced by spark plugs.
